(19) United States
(12) Patent Application Publication
(10) Pub. No.: US 2004/0253495 A1
(43) Pub. Date: Dec. 16, 2004

(54) Fuel cell device condition detection

(76) Inventor: Arne LaVen, Bend, OR (US)

Correspondence Address: KOLISCH HARTWELL, P.C., 520 S.W. YAMHILL STREET, SUITE 200, PORTLAND, OR, 97204, US

(21) Appl. No.: 10/460,800

(22) Filed: Jun. 11, 2003

(51) Int. Cl. H01M 8/04

(52) U.S. Cl. 429/23; 429/13

(57) ABSTRACT

Assemblies and methods for monitoring the voltage condition of a fuel cell device. The monitoring may be provided without direct electrically conductive or mechanical contact with the fuel cell device. This may be provided by a detector coupled to a pair of electrical contacts on a fuel cell device that is adapted to produce electromagnetic energy, or radiation, indicative of the voltage between the pair of electrical contacts. Accordingly, a monitor that is spaced from the detector may be used to detect the produced electromagnetic energy and produce an output signal representative of the voltage difference. In some examples, a plurality of fuel cell devices or overlapping sets of fuel cell devices may be monitored. A digital signal may be generated, providing a simplified indication of the operating condition of one or a plurality of fuel cell devices. Multiple digital signals may be used to provide additional information.

### TECHNICAL FIELD

The present disclosure relates generally to fuel cell assemblies, and more particularly to assemblies and methods for detecting the voltages output by fuel cell devices. A fuel cell device is a device that includes one or more fuel cells.

### BACKGROUND OF THE DISCLOSURE

An electrochemical fuel cell is a device that converts fuel and an oxidant to electricity, a reaction product, and heat. For example, fuel cells may be adapted to convert hydrogen and oxygen into water and electricity. In such fuel cells, the hydrogen is the fuel, the oxygen is the oxidant, and the water is the reaction product.

The amount of electricity produced by a single fuel cell may be supplemented by connecting several fuel cells together. Fuel cells connected together in series are often referred to as a fuel cell stack. The voltage produced by individual fuel cells or groups of fuel cells in a fuel cell stack is an indication of the functioning of the cells. It is possible for a cell to deteriorate or otherwise malfunction. This malfunction can produce a reduction in or even a reversal of the voltage produced by a cell.

Historically, monitoring of fuel cell operation has been accomplished through physical attachment of an analogue voltage-measuring circuit. Due to the fragility of fuel cell and fuel cell stack structures, these attachments can cause damage and short-circuiting of cells.

### SUMMARY OF THE DISCLOSURE

The present disclosure relates to an assembly and a method for detecting the voltage produced by one or more fuel cells or groups of fuel cells, which are referred to herein generally as a fuel cell device. In some examples, monitoring is provided by a monitor that is not in direct electrically conductive or mechanical contact with the fuel cell device or devices. An example of such an assembly includes a detector coupled to a pair of electrical contacts on a fuel cell device that is adapted to produce electromagnetic energy indicative of the voltage between the pair of electrical contacts. Accordingly, a further example includes a monitor that is not in physical contact with the voltage detector or the fuel cell device or devices being monitored. The monitor is adapted to detect the produced electromagnetic energy and produce an output signal representative of the voltage difference detected on the fuel cell device or devices.

In some examples, the voltage on each of a plurality of fuel cell devices and/or overlapping groups of fuel cell devices is detected. In some examples, each detected voltage is monitored. When any one of the fuel cell devices or groups of fuel cell devices has a voltage outside of a range of acceptable voltages, an indication is provided, such as a change in a light or other detectable signal. In some examples, a logic circuit determines when any of the fuel cell devices or groups of fuel cell devices is operating outside the range of acceptable voltages, and produces an indication of that condition. In further examples, a digital signal is generated, providing a simplified indication of the operating condition of one or a plurality of fuel cell devices, or multiple digital signals are used to provide additional functioning information, such as when voltages on overlapping groups of fuel cell devices are detected.

### BRIEF DESCRIPTION OF THE DRAWINGS

FIG. 1 is a schematic view of a fuel cell.

FIG. 2 is a schematic view of a fuel cell system that includes a fuel cell stack.

FIG. 3 is a schematic diagram illustrating an example of a fuel cell assembly according to the present disclosure.

FIG. 4 is a schematic diagram illustrating another example of a fuel cell assembly according to the present disclosure.

FIG. 5 is a fragmentary schematic view of a fuel cell stack with a plurality of fuel cells, as may be used in fuel cell assemblies according to the present disclosure.

FIG. 6 is a simplified fragmentary schematic view illustrating different arrangements of detector devices used to monitor a plurality of fuel cells according to the present disclosure.

FIG. 7 is a schematic diagram of a detector device as may be used in a fuel cell assembly according to the present disclosure.

FIG. 8 is a fragmentary, partially exploded view of a fuel cell assembly according to the present disclosure.

FIG. 9 is a schematic diagram of another example of a detector device, as may be used in a fuel cell assembly according to the present disclosure.

FIG. 10 is a schematic diagram of yet another example of a detector device, as may be used in a fuel cell assembly according to the present disclosure.

FIG. 11 is a schematic diagram of a combination of a detector and a monitor, as may be used in a fuel cell assembly according to the present disclosure.

FIG. 12 is a further schematic diagram of another combination of a detector and a monitor, as may be used in a fuel cell assembly according to the present disclosure.

FIG. 13 is a general schematic diagram of a processor and an output device, as may be used in a fuel cell assembly according to the present disclosure.

### DETAILED DESCRIPTION AND BEST MODE OF THE DISCLOSURE

Methods and assemblies are disclosed for monitoring a fuel cell or groups of fuel cells, referred to generally as fuel cell devices, in a manner that allows detection of fuel cell device operating conditions without physically contacting the fuel cell devices. As used herein, the term “fuel cell device” generally refers to one or more fuel cells and/or devices that include one or more fuel cells. Illustrative examples of fuel cell devices include a fuel cell, a group of fuel cells, a fuel cell stack, a fuel cell system, and an energy producing and consuming assembly that includes one or more fuel cells.

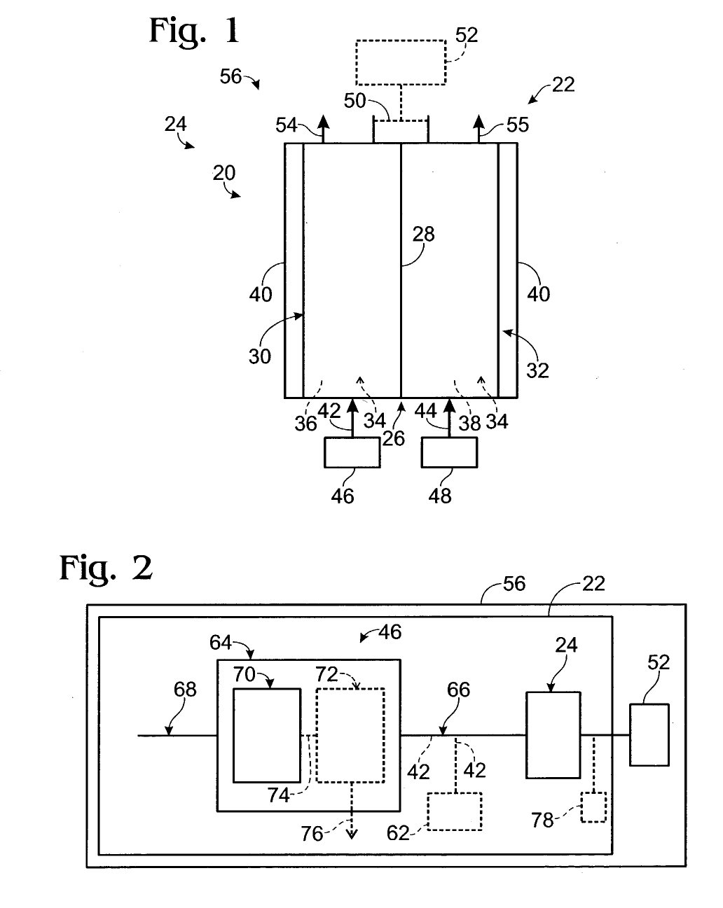

The subsequently discussed fuel cell devices are compatible with a variety of different types of fuel cells, such as proton exchange membrane (PEM) fuel cells, as well as alkaline fuel cells, solid oxide fuel cells, molten carbonate fuel cells, phosphoric acid fuel cells, and the like. For the purpose of illustration, an exemplary fuel cell 20 in the form of a PEM fuel cell is schematically illustrated in FIG. 1 and generally indicated at 22 as part of a fuel cell system, or as part of a fuel cell stack 24. Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a supporting plate 40, such as at least a portion of the bipolar plate assemblies that are discussed in more detail herein. The supporting plates 40 of fuel cell 20 carry the relative voltage potential produced by the fuel cell.

In operation, hydrogen 42 is fed to the anode region, while oxygen 44 is fed to the cathode region. Hydrogen 42 and oxygen 44 may be delivered to the respective regions of the fuel cell via any suitable mechanism from respective sources 46 and 48. Examples of suitable sources 46 for hydrogen 42 include a pressurized tank, hydride bed or other suitable hydrogen storage device, and/or a fuel processor that produces a stream containing hydrogen gas. Examples of suitable sources 48 of oxygen 44 include a pressurized tank of oxygen or air, or a fan, compressor, blower or other device for directing air to the cathode region. Hydrogen and oxygen typically combine with one another via an oxidation-reduction reaction. Although membrane 28 restricts the passage of a hydrogen molecule, it will permit a hydrogen ion (proton) to pass therethrough, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 1.

In practice, a fuel cell stack contains a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load.

At least one energy-consuming device 52 may be electrically coupled to the fuel cell, or more typically, the fuel cell stack. Device 52 applies a load to the cell/stack and draws an electric current therefrom to satisfy the load. Illustrative examples of devices 52 include motor vehicles, recreational vehicles, boats and other seacraft, and any combination of one or more residences, commercial offices or buildings, neighborhoods, tools, lights and lighting assemblies, appliances, computers, industrial equipment, signaling and communications equipment, batteries and even the balance-of-plant electrical requirements for the fuel cell system of which stack 24 forms a part. An energy producing and consuming assembly, which is illustrated generally in FIG. 1 at 56, includes at least one fuel cell system 22 and one energy-consuming device 52.

In cathode region 32, electrons from the external circuit and protons from the membrane combine with oxygen to produce water and heat. Also shown in FIG. 1 are an anode purge stream 54, which may contain hydrogen gas, and a cathode air exhaust stream 55, which is typically at least partially, if not substantially, depleted of oxygen. It should be understood that fuel cell stack 24 will typically have a common hydrogen (or other reactant) feed, air intake, and stack purge and exhaust streams, and accordingly will include suitable fluid conduits to deliver the associated streams to, and collect the streams from, the individual fuel cells. Similarly, any suitable mechanism may be used for selectively purging the regions.

As discussed above, some fuel cell stacks utilize hydrogen gas as a reactant, or fuel. Therefore, a fuel cell stack 24 may be coupled with a source 46 of hydrogen gas 42 (and related delivery systems and balance of plant components) to form a fuel cell system 22. An illustrative example of a fuel cell system is schematically illustrated in FIG. 2. As discussed previously with respect to FIG. 1, examples of sources 46 of hydrogen gas 42 include a storage device 62 that contains a stored supply of hydrogen gas, as indicated in dashed lines in FIG. 2. Examples of suitable storage devices 62 include pressurized tanks and hydride beds. An additional or alternative source 46 of hydrogen gas 42 is the product stream from a fuel processor, which produces hydrogen by reacting a feed stream to produce reaction products from which the stream containing hydrogen gas 42 is formed. As shown in solid lines in FIG. 2, system 22 includes at least one fuel processor 64 and at least one fuel cell stack 24. Fuel processor 64 is adapted to produce a product hydrogen stream 66 containing hydrogen gas 42 from a feed stream 68 containing at least one feedstock. The fuel cell stack is adapted to produce an electric current from the portion of product hydrogen stream 66 delivered thereto. In the illustrated example, a single fuel processor 64 and a single fuel cell stack 24 are shown; however, more than one of either or both of these components may be used. These components have been schematically illustrated and the fuel cell system may include additional components that are not specifically illustrated in the figures, such as air delivery systems, heat exchangers, heating assemblies and the like. As also shown, hydrogen gas may be delivered to stack 24 from one or more of fuel processor 64 and storage device 62, and hydrogen from the fuel processor may be delivered to one or more of the storage device and stack 24. Some or all of stream 66 may additionally, or alternatively, be delivered, via a suitable conduit, for use in another hydrogen-consuming process, burned for fuel or heat, or stored for later use.

Fuel processor 64 is any suitable device that produces hydrogen gas from the feed stream. Accordingly, fuel processor 64 may be described as including a hydrogen-producing region 70 in which a stream that is at least substantially comprised of hydrogen gas is produced from a feed stream. Examples of suitable mechanisms for producing hydrogen gas from feed stream 68 include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 68 may be delivered to fuel processor 64 via any suitable mechanism. Although only a single feed stream 68 is shown in FIG. 2, more than one stream 68 may be used and these streams may contain the same or different feedstocks.

In many applications, it is desirable for the fuel processor to produce at least substantially pure hydrogen gas. Accordingly, the fuel processor may utilize a process that inherently produces sufficiently pure hydrogen gas, or the fuel processor may include suitable purification and/or separation devices that remove impurities from the hydrogen gas produced in the fuel processor. When region 70 does not produce pure hydrogen gas, stream 66 may include one or more of such illustrative impurities as carbon monoxide, carbon dioxide, water, methane, and unreacted feedstock. As another example, the fuel processing system or fuel cell system may include one or more purification and/or separation devices downstream from the fuel processor. This is schematically illustrated in FIG. 2, in which a separation region 72 is shown in dashed lines. When fuel processor 64 includes a separation region 72, the hydrogen-producing region may be described as producing a mixed gas stream that includes hydrogen gas and other gases. Similarly, many suitable separation regions will produce from this mixed gas stream at least one product stream, such as stream 66, that contains at least substantially pure hydrogen gas and at least one byproduct stream that contains at least a substantial portion of the other gases. A mixed gas stream and a byproduct stream are schematically illustrated in FIG. 2 at 74 and 76, respectively.

Separation region 72 may utilize any suitable pressure-driven or other process for increasing the purity of the hydrogen gas and/or decreasing the concentration of one or more other gases (such as carbon monoxide and/or carbon dioxide) that may be mixed in with hydrogen gas. Non-exclusive examples of suitable pressure-driven separation processes include the use of one or more hydrogen-selective membranes and the use of a pressure swing adsorption system. The separation region, or regions, may be housed with the hydrogen-producing region within a common shell, attached to the fuel processor, or separately positioned from the fuel processor (but still in fluid communication therewith). An illustrative example of a suitable structure for reducing the concentration of any carbon monoxide in stream 74 is a methanation catalyst, although carbon monoxide removal assemblies or other chemical purification assemblies may be used within the scope of the present disclosure.

In the context of a fuel cell system, the fuel processor preferably is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 6,221,117, 5,997,594, 5,861,137, and pending U.S. patent application Ser. No. 09/802,361. The complete disclosures of the above-identified patents and patent application are hereby incorporated by reference for all purposes.

FIG. 2 also schematically depicts that fuel cell systems 22 may (but are not required to) include at least one energy-storage device 78. Device 78 is adapted to store at least a portion of the current produced by fuel cell stack 24. More particularly, the current may establish a potential that can be later used to satisfy an applied load, such as from energy-consuming device 52 and/or fuel cell system 22. Energy-consuming device 52 may be adapted to apply its load to one or more of stack 24 and energy-storage device 78. An illustrative example of a suitable energy-storage device 78 is a battery, but others may be used, such as ultra capacitors and flywheels. Device 78 may additionally or alternatively be used to power the fuel cell system during startup of the system.

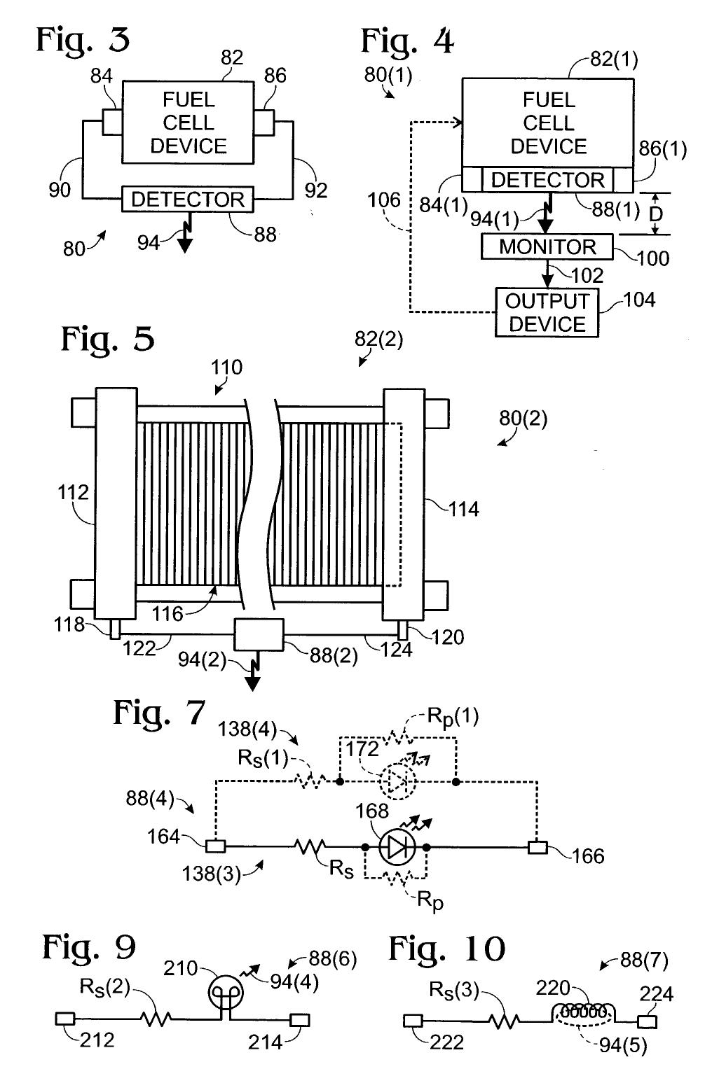

A general schematic diagram of a fuel cell assembly 80 is shown in FIG. 3. The fuel cell assembly includes a fuel cell device 82 that produces, during operation, a voltage potential between a pair of electrical contacts 84 and 86. Examples of such fuel cell devices include a fuel cell 20, a fuel cell system 22, a fuel cell stack 24, and an energy producing and consuming assembly 56, such as have been described with reference to FIGS. 1 and 2. Contacts 84 and 86 have been schematically depicted in FIG. 3 and include contacts that are accessible from a variety of locations depending on the structure of the device. As discussed, a fuel cell device includes a single fuel cell, or a plurality of fuel cells. As has also been described, each fuel cell is individually adapted to convert fuel and an oxidant into an electric current. The fuel cells are typically electrically coupled in series, although configurations are included in which the fuel cells are coupled in parallel or in a combination of series and parallel. When electrically coupled, the cells collectively provide an electric potential dependent on the configuration of the device. For example, if all cells are electrically coupled in series, the electrical potential provided by the device is the sum of the respective potentials of the cells. Similarly, the number of fuel cells included is a matter of choice depending on the application, such as depending upon the desired power output of the fuel cell device.

A detector 88 is connected to the contacts by conductors 90 and 92. As used herein, a detector is a device, apparatus, assembly, circuit or element that transmits, emits, and/or produces electromagnetic energy based on an operating condition of a fuel cell device. For example, detector 88 may be a device adapted to generate electromagnetic energy 94 in response to and representative of the voltage that exists between the contacts. As will become apparent, examples of detector 88 include an energy transmitter or emitter, such as an inductor, a current conductor, a light emitting semiconductor, a laser or other illumination source, including any circuits of which such devices form a part. The electromagnetic energy is adapted to be monitored remotely from the detector. Examples of such electromagnetic energy include an electric field, a magnetic field, and radiation. Electromagnetic radiation is any usable and detectible form, including ultraviolet radiation, visible light, infrared radiation, and radio waves.

Detector 88 is supported relative to fuel cell device 82. Illustrative examples of suitable support mechanisms, or methods of supporting detector 88 relative to fuel cell device 82 include constructing the detector integrally with fuel cell device 82, physically attaching the detector to the fuel cell device, and supporting the detector independently of the fuel cell device. It is sufficient that the detector is suitably coupled to contacts 84 and 86 so that an indication of the voltage produced by the device is detected by the detector. Conductors 90 and 92 are shown symbolically in FIG. 3 as lines, and it is within the scope of the present disclosure that the conductors may take any form, provided that they provide communication of information representative of the voltage potential across the fuel cell device. In the general sense, this communication may be provided by wired or wireless communication links. In some examples, the energy produced by the fuel cell device is used by the detector. Examples of communication that allow transfer of the energy include adaptations that provide for the conduction of electrical current from the fuel cell device to the detector, such as terminals, electrodes, wires, metal traces, conductive surface elements, conductive adhesives and the like.

In the description and the associated figures, parenthetical numbers are used as in certain reference numbers to illustrate examples and variations of the previously identified structure. It is within the scope of the present disclosure that these related structures may (but are not required to) include any or all of the elements, subelements, variations, properties and the like as any of the other versions described, illustrated and/or incorporated herein.

A second example of a fuel cell assembly 80 is shown as a fuel cell assembly 80(1) in schematic block form in FIG. 4. Fuel cell assembly 80(1) includes a fuel cell device 82(1) and a detector 88(1) producing electromagnetic energy 94(1). Detector 88(1) is illustrated as being attached to device 82(1) and in contact with electrical contacts 84(1) and 86(1). Detector 88(1) (and the other detectors disclosed herein) may produce any suitable electromagnetic signal. Therefore, it is within the scope of the present disclosure that the detector may be configured to produce steady state or oscillatory signals. For example, an oscillatory signal may have a frequency, phase and/or amplitude that is related, or correlated, to the voltage between the contacts, or detection points. A benefit of an oscillatory signal is that is may provide for a greater range of distance between the detector and a corresponding monitor.

As illustrated, assembly 80(1) further includes a monitor 100. Monitor 100 is adapted to produce, responsive to electromagnetic energy 94(1), an output signal that is representative of the electromagnetic energy produced by detector 88(1), and correspondingly representative of the fuel cell device voltage. Any suitable monitor structure may be used. The output signal may be produced on an output signal path 102. In such a configuration, an output device 104 may be coupled to output signal path 102 for producing the output signal. This signal may be used to determine the operating condition of the detected fuel cell device, and it is within the scope of the disclosure to control the operation of the corresponding fuel cell system at least partially responsive thereto. It is accordingly within the scope of the present disclosure that any of the illustrative fuel cell assemblies described and/or illustrated herein may be implemented with or without a monitor. Similarly, the illustrative examples are intended to collectively demonstrate exemplary configurations, embodiments, optional components and the like, with it being within the scope of the disclosure that components, structure, elements, variants and the like that are described and/or illustrated with respect to a particular illustrative embodiment may be selectively utilized with other described and/or illustrated embodiments.

Because the monitor is responsive to the electromagnetic energy produced by the detector, the monitor does not have to be in contact with, or be part of the detector. In this example, the monitor is physically separated from the detector at any distance D at which the electromagnetic energy may be detected. Thus, the potential for adverse physical impact of the monitor on the fuel cell device, such as physical damage, is reduced. It will be appreciated that by making the electromagnetic energy the medium for conveying the information about the operating condition of the fuel cell device, the monitor may also be electrically isolated from the detector and fuel cell device. However, it is still within the scope of the present disclosure that monitor 100 may be in physical contact with the detector.

The monitor and output device are configured in any suitable configuration to accomplish the functions described herein. For example, the monitor and output device may be formed as a single unit or separate units. Furthermore, the monitor and output device may be in contact, in close proximity, or in remote locations relative to each other. As a further example, the monitor may include a sensor or transducer that detects the electromagnetic energy and produces an analog output signal proportional to the level of the electromagnetic energy. Optionally, the monitor may include an analog or digital circuit, such as a processor or multiplexer, that converts the signal into other forms of information that are conveyed via the output signal path to one or more output devices. The output device may (but is not required to) include a processor or controller, such as a computer or microprocessor, that analyzes the output signal and controls operation of the fuel cell device, as represented by dashed lines 106. It is within the scope of the present disclosure that the output device may include one or more communication channels or links to a local Or remote apparatus, and one or more simple analog or digital displays, or visible or audible alarms.

FIG. 5 schematically depicts a further example of a fuel cell assembly 80(2). Assembly 80(2) includes a fuel cell device 82(2) and a detector 88(2). Fuel cell device 82(2) is in the form of a fuel cell stack 110. Stack 110 includes end plates 112 and 114 that are positioned on opposite ends of the stack. Stack 110 also includes a plurality of fuel cells, or fuel cell assemblies, 116, which are physically arranged between end plates 112 and 114. In examples in which all fuel cells are electrically coupled in series, the voltage provided by the stack is the sum of the voltages of the individual fuel cells. Stack 110 is shown with a positive contact 118 and negative contact 120, across which a load is adapted to be electrically coupled. These contacts are schematically depicted in FIG. 5 and are adapted to be accessed from a variety of locations. Similarly, the number of fuel cells 116 in any particular stack is a matter of design choice, and is selected based upon, for instance, the desired power output of the fuel cell stack and the design and capabilities of the individual cells.

As part of assembly 80(2), detector 88(2) is adapted to be connected to contacts 118 and 120 via respective conductors 122 and 124. Based on the voltage between contacts 118 and 120, detector 88(2) is adapted to produce electromagnetic energy 94(2).

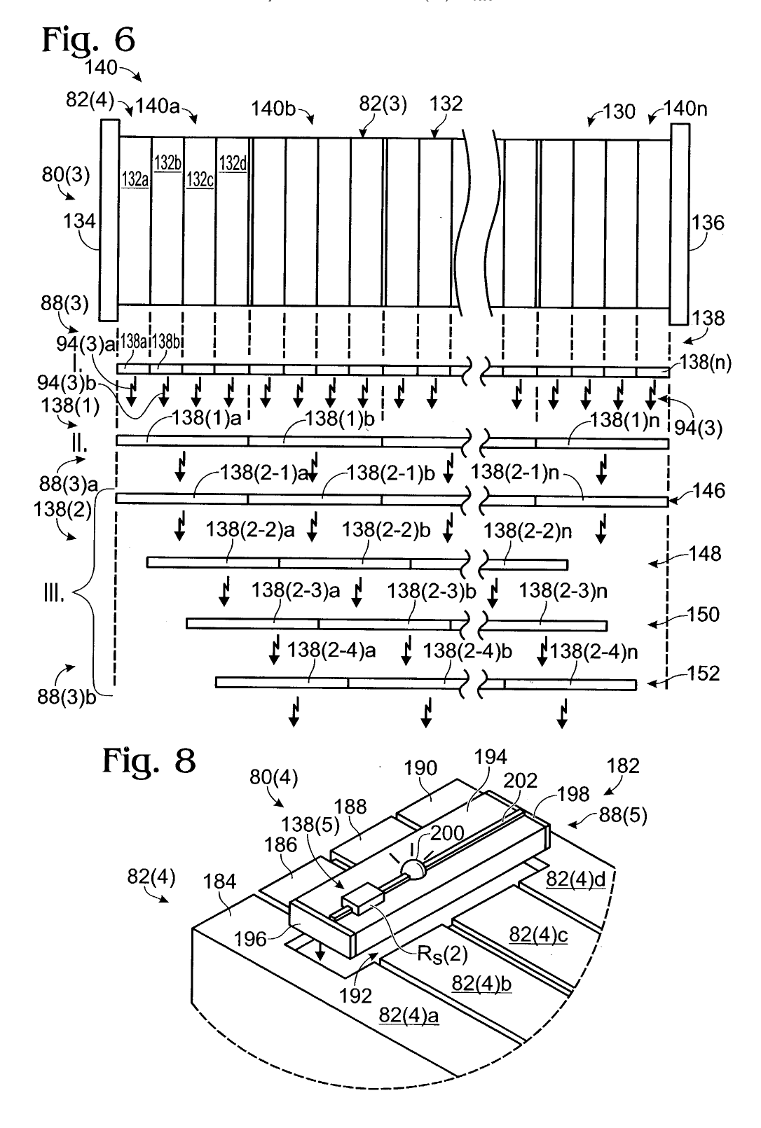

A general schematic diagram of a fuel cell stack 130, as part of yet another illustrative fuel cell assembly 80(3) is shown in FIG. 6. Stack 130 includes a plurality fuel cell devices 82(3) in the form of fuel cells 132, such as cells 132a and 132b, that are positioned between end plates 134 and 136. It is within the scope of the disclosure that there are many configurations possible for monitoring the functionality of the fuel cells. In one example, they are monitored as a group, such as shown in FIG. 5. In another example, the cells are adapted to be monitored individually or in groups of cells. To graphically illustrate examples of these, three further configurations for monitoring fuel cell devices, identified as configurations I, II, and III, are illustrated in FIG. 6. In configuration I, each cell 132 is monitored. A detector 88(3) thus includes a detector device 138 associated with each cell 132. Accordingly, detector devices 138 are adapted to produce electromagnetic energy 94(3) that is representative of the voltage produced by each fuel cell device 82(3). For example, detector devices 138a and 138b sense the voltages produced by cells 132a and 132b, and produce electromagnetic energy 94(3)(a) and 94(3)(b), respectively, based on the sensed voltages.

In configuration II, groups of four cells 132 are monitored by a detector 88(3)a that includes detector devices 138(1). As a variation of this, each group 140 is considered to be a fuel cell device 82(4). Representative groups of cells include groups 140a, 140b, and 140n. Detector 88(3)a accordingly includes corresponding detector devices 138(1)a, 138(1)b, and 138(1)n. It is within the scope of the disclosure that the number of cells in each group may vary, such as with each group including two cells, three cells, or more than four cells.

Configuration III discloses a detector 88(3)b formed by overlapping groupings of detector devices 138(2), that, as is discussed in further detail subsequently, collectively provide more information about the functionality of cells within each group. This configuration includes illustrative examples of first, second, third and fourth sets 146, 148, 150 and 152 of detector devices. In this example, each detector device 138(2) monitors the voltage on four serially connected fuel cells. First set 146 of detector devices 138(2-1) includes detector devices 138(2-1)a, 138(2-1)b, and 138(2-1)n. These detector devices are respectively connected to the same sets of cells as detector devices 138. It is within the scope of the disclosure that the number of cells monitored by each detector device, and/or the degree of overlap between the detector devices may vary, such as to include greater or lesser extents than presented in the illustrative graphical example.

In the illustrative example, each successive set is staggered by one fuel cell, so that the four sets monitor four combinations of groups of four adjacent fuel cells. Second set 148 of detector devices 138(2-2) includes detector devices 138(2-2)a, 138(2-2)b, and 138(2-2)n. Third set 150 of detector devices 138(2-3) includes detector devices 138(2-3)a, 138(2-3)b, and 138(2-3)n. Similarly, fourth set 152 of detector devices 138(2-4) includes detector devices 138(2-4)a, 138(2-4)b, and 138(2-4)n. It is seen that the fuel cell devices monitored by the detector devices in sets 148, 150 and 152 of device detectors 138(2-2), 138(2-3) and 138(2-4), respectively, are offset to the right by one fuel cell device, as viewed in FIG. 6, compared to the device detectors immediately above them. As a result, other than the three fuel cell devices on each end, each of the fuel cell devices is monitored as part of each of four different groups of fuel cell devices. As an example, fuel cell device 132d is one of four fuel cell devices monitored by each of detector devices 138(2-1)a, 138(2-2)a, 138(2-3)a, and 138(2-4)a.

Each fuel cell device is monitored as part of a group by a given detector device. Thus, if one of the cells deteriorates, the deterioration must be sufficient to indicate that the group of fuel cell devices has deteriorated sufficiently to require remedial action. The smaller the group that is monitored, the more specific the information provided by the associated detector, and the greater each fuel cell device contributes to the operation of the group. Since other fuel cells can offset the deterioration of one of the fuel cells in a group of fuel cells, the larger the group monitored, the less likely it is that a deteriorated cell will be detected.

In some applications, it may be desired to determine when the operating voltage of any cell drops below a threshold value, but the detector devices are designed to measure the voltage of a group of fuel cell devices. In such situations, increased information is obtained using offset and/or partially redundant monitoring. The increased level of information, though, requires the use of an increased number of detecting devices.

As an example, if a fuel cell has a normal operating voltage of about 0.6 volts, then four cells in a group have a combined normal operating voltage of about 2.4 volts. If 0.5 volts or less, on the average, indicates a failed group of cells, then a detected voltage below 2.0 volts will be treated as a failed group of cells. As used herein, the terms “normal operating,” “nominal,” “go,” and “non-failed” may be used to describe the detected voltage, or voltage potential, of an operational fuel cell device. The terms “failed,” “lower threshold,” “reduced,” “inoperational,” “weak,” and “no go” may be used to describe detected voltages, or voltage potentials, that are less than the normal operating voltages.

It is within the scope of the disclosure that the fuel cell assemblies, detectors, monitors and other structure disclosed herein may be configured for use with fuel cells that have normal operating voltages that are greater than or less than the illustrative voltage presented above. Similarly, other “failed,” or lower threshold, voltages may be used, such as 0.1 volts, 0.3 volts, 0.4 volts, voltages in the range of 0 and 0.5 volts, voltages of 25%, 50%, 75% or in the range of 10-90% of the normal operating voltages, etc. may be used without departing from the scope of the disclosure. It is also within the scope of the disclosure that the fuel cell assemblies may be configured to detect and selectively respond to more than one threshold voltage, such as a lower threshold that indicates a failed fuel cell device and an intermediate threshold that is between the normal operating voltage and the lower threshold. This intermediate threshold may indicate, for example, a weak cell that has not yet deteriorated to the point of failure. This response may include, for example, producing different levels of electromagnetic radiation responsive to the detection of different levels of voltage between the corresponding (electrical) contacts. Accordingly, detecting more than go/no go may provide a mechanism for early detection of a weak (or impending failed) cell or other fuel cell device.

The tables below give examples of the information obtained when monitoring using the three exemplary configurations illustrated in FIG. 6.

TABLE I

| | | Configuration I: | | | | | | | |
|---|---|---|---|---|---|---|---|---|---|
| Fuel Cell Device | d | e | f | g | h | i | j | k | l |
| Fuel Cell Device Voltage | .6 | .6 | .6 | .6 | .1 | .6 | .6 | .6 | .6 |
| Detector Output | 1 | 1 | 1 | 1 | 0 | 1 | 1 | 1 | 1 |

In Table I, every fuel cell device has a detector that generates a favorable output so long as the voltage is 0.5 volts or higher. All of the fuel cell devices, including those not shown, have a normal voltage of 0.6 volts except for device “h,” which has an unacceptable voltage of 0.1 volts. A favorable output is shown as a “1” and an unfavorable output is shown as a “0.” This, then, is an example of a simple “go/no go” form of output that is readily converted into a digital format for further processing. That is, if one of the fuel cell devices is failed, the entire fuel cell assembly is shut down and the failed fuel cell device is repaired or replaced. The above convention for reducing an analog signal to a digital signal is meant for the purpose of illustration and not limitation. Accordingly, it is within the scope of the present disclosure that any suitable convention may be used, including one in which the above convention is reversed. A variation from the digital form of output is an analog output in which the detector produces an output directly proportional to the detected voltage. In another example, a series of prioritized discrete outputs is generated, so that general intermediate levels of fuel cell device operation are indicated. This latter approach provides outputs indicating “high,” “normal,” “low” and “failed” levels of fuel cell operation. The form of output is generated based on the needs of a particular application.

In some situations, the cost and complexity of monitoring individual fuel cells outweighs the benefits of detecting the conditions of the individual fuel cells. In such situations, another option includes detecting the conditions of groups or modules of cells. This might be desirable, for instance, if fuel cells are provided in modules, or other groupings, that are adapted to be installed and/or removed as a unit. This option is illustrated in Table II.

TABLE II

| | Configuration II: | | | | | | | | |
|---|---|---|---|---|---|---|---|---|---|
| Fuel Cell Device | d | e | f | g | h | i | j | k | l |
| Fuel Cell Device Voltage | .6 | .6 | .6 | .6 | .1 | .6 | .6 | .6 | .6 |

| | | |
|---|---|---|
| Fuel Cell Device Group | d-g | h-k |
| Group Voltage | 2.4 | 1.9 |
| Detector Output | 1 | 0 |

More specifically, in Table II, each detector detects the combined voltage of four serially connected fuel cell devices. The fuel cell devices have the same voltage levels as shown in Table I. The group or module consisting of fuel cell devices d-g has a voltage of 2.4 volts, whereas the group consisting of fuel cell devices h-k has a voltage of 1.9 volts. Since the voltage for this second group is below the adopted minimum level of 2.0 volts for the group, it is considered to be at an unacceptable level. The results of this configuration do not indicate which of the four devices is malfunctioning, or whether the reduced voltage is due to the combined malfunction of more than one device. If the group consisted of five devices instead of four, all of the groups would appear to be functioning within the average level, and a favorable output would be generated for all of the groups. As a further example, if the malfunctioning device produced a voltage of 0.2 volts, the outputs in Table II would all be favorable. It is therefore apparent that the smaller the number of devices that make up a group, the more accurate the information.

TABLE III

| | Configuration III: | | | | | | | | | |
|---|---|---|---|---|---|---|---|---|---|---|
| Fuel Cell Device | | d | e | f | g | h | i | j | k | l |
| Fuel Cell Device Voltage | | .6 | .6 | .6 | .6 | .1 | .6 | .6 | .6 | .6 |

| | | | | |
|---|---|---|---|---|
| Fuel Cell Device Group (1) | | d-g | h-k | |
| Group Voltage | . . . | 2.4 | 1.9 | . . . |
| Detector Output | | 1 | 0 | |

| | | | | |
|---|---|---|---|---|
| Fuel Cell Device Group (2) | | e-h | i-l | |
| Group Voltage | . . . | 1.9 | 2.4 | . . . |
| Detector Output | | 0 | 1 | |

| | | | | |
|---|---|---|---|---|
| Fuel Cell Device Group (3) | | f-i | j-m | |
| Group Voltage | . . . | 1.9 | 2.4 | . . . |
| Detector Output | | 0 | 1 | |

| | | | | |
|---|---|---|---|---|
| Fuel Cell Device Group (4) | | g-j | k-n | |
| Group Voltage | . . . | 1.9 | 2.4 | . . . |
| Detector Output | | 0 | 1 | |

Table III illustrates monitoring as provided by configuration III in which the detectors detect staggered, overlapping groups of four devices, with each device included in four unique groups. Again, the devices are producing the same individual voltages as in the previous two tables. This configuration inherently has redundancy in detecting the condition of the fuel cells, since each device contributes to each detected group. This redundancy provides more opportunities for detecting a malfunctioning fuel cell device. As mentioned with reference to FIG. 6, in this example, the devices on the ends do not benefit from the full redundancy of the intermediate devices. Any group containing the device “h” has an output indicating one or more devices are malfunctioning.

However, from the information provided in this example, the individual faulty device may be identified. This is determined from the observation that all of the groups that do not include device “h” have a favorable output, leading to the conclusion that only device “h” is faulty. In some examples, then, a fuel cell assembly includes logic circuitry or functions that provide for the analysis of the outputs received from the series of detectors or monitors. Configuration III has about the same number of detector devices as Configuration I. However, information about individual devices must be deduced, rather than being directly determined. Due to the redundancy, Configuration III provides much more information than that provided in the detection of separate modules as demonstrated by Configuration II. Accordingly, Configuration III is appropriate, then, where it is impractical to detect the voltages of individual devices, but information on a detailed level is desired.

Referring now to FIG. 7, a further example of a detector is shown generally at 88(4). Detector 88(4) includes a detector device 138(3) coupled between terminals 164 and 166. Terminals 164 and 166 are adapted to be connected to contacts of one or a plurality of fuel cell devices, as has been described. Terminals 164 and 166 are exemplary, and may be any form of electrical conductor that is adapted to be connected to contacts of the fuel cell device, as has been described regarding conductors 90 and 92 of fuel cell assembly 80. Detector device 138(3) is an electrical circuit that is powered by and operates using the energy produced by the fuel cell device(s) to which it is connected.

Device 138(3) includes any suitable semiconductor device that is biased, or otherwise configured, to operate when the voltage difference is at least a determined value, or magnitude. For example, a semiconductor device may be configured to operate when the voltage difference is a selected percentage of the normal operating voltage of the fuel cell device. Illustrative examples include 50%, 70%, 75%, 80%, 90% and 100%. In FIG. 7, an illustrative semiconductor device in the form of a photodiode 168, such as a light-emitting diode (LED), is shown. Optionally, a silicon diode, a resistor, and a light source in series may be used. In dashed lines in FIG. 7, an optional resistor Rₚ is shown connected electrically in parallel with a diode 168. The parallel combination of diode 168 and resistor Rₚ is connected in series with a resistor Rₛ. Resistor Rₛ is a current-limiting element. Detector device 138(3) has two operating states: one in which the LED is operating and one in which it is not operating. The addition of resistor Rₚ enables increased tuning of the detector, which may be beneficial in some embodiments. However, and unlike the illustrative embodiment shown in solid lines in FIG. 7, it also imparts an impedance (Rₛ+Rₚ) to be connected to the fuel cell stack. In contrast, the illustrative example shown in solid lines in FIG. 7 may be described as a detector that is configured to not impart an electrical load to the fuel cell stack when the stack is not in a current-producing operating state. This configuration may be beneficial in situations where the anode of the fuel cells in the stack may be decomposed or otherwise damaged if a load is applied to the stack when the stack is not currently configured to produce an electric current.

The values of the resistors, the operating voltage of the fuel cell device(s) being monitored, and the voltage, or threshold, level at which an alarm, or faulted, condition is to occur contribute to the operation of the diode. Silicon diodes are known to require a forward bias of about 0.7 volts before they become operational. In contrast, germanium diodes require about 0.3 volts to “turn on.” In the example given above, a single fuel cell produces a voltage of about 0.6 volts during normal operation. A single fuel cell would therefore not turn on a silicon diode, but it would be sufficient to turn on a germanium diode. Thus, germanium diodes may be used for any of the configurations illustrated in FIG. 6, but silicon diodes would be functional to detect the operating condition of groups of two or more of such fuel cells when the fuel cells are relied upon to provide the power to operate the detector. Correspondingly, LED-type diodes typically operate with a forward conducting voltage in the range of approximately 1.8-2.1 volts. Therefore, such LED-type diodes, or LED's, are conventionally best-suited for groups of at least three or four fuel cells.

Values for resistors Rₛ and Rₚ are chosen to draw a low level of current, such as about 10 ma. As a first example, if detector 28(4) spans four serially connected fuel cells producing about 0.6 volts each, then a normal voltage potential of 2.4 volts will exist on terminals 164 and 166. Selecting Rₛ=170 ohms, the voltage is divided between the diode, having about 0.7 volts, and resistor Rₛ, which has 1.7 volts. This results in a normal operating current of 10 ma. If it is desired to have the diode turn off at an average fuel cell voltage of 0.5 volts and a total voltage of 2.0 volts, then the parallel resistor Rₚ is given a value of 91.5 ohms. Then 0.7 volts appears across both the resistor Rₚ and the diode, and 1.3 volts appears across resistor Rₛ. For voltages greater than 2.0 volts, the diode ideally acts as a short, effectively bypassing resistor Rₚ, and maintains a voltage drop of about 0.7 volts. Below a total voltage of 2.0 volts, resistor Rₚ has less than 0.7 volts, and the diode is turned off. When an LED diode having a conducting voltage of about 2 volts is used, resistor Rₚ may be omitted from this illustrative example. When the diode is not biased on, it presents a very large resistance to the circuit, and correspondingly conducts very little current.

An additional level of information about the condition of the group of fuel cells being detected may be obtained by adding to detector 28(4) a second detector device 138(4), such as shown in dashed lines in FIG. 7. Detector device 138(4) is similar to device 138(3), and includes resistors Rₛ(1) and, optionally, Rₚ(1), and a light-source/diode 172. In this case, the detector device is adapted to produce electromagnetic radiation when the group of fuel cells being monitored is at least 0.4 volts per fuel cell. This means that for four fuel cells the combined produced voltage is about 1.6 volts. If diode 172 is a silicon diode, then when the total voltage equals 1.6 volts, 0.7 volts appears on the diode and resistor Rₚ(1), and 0.9 volts appears across resistor Rₛ(1). If we set Rₛ(1)=170 ohms so that 10 ma of current flows at normal operating levels, then when Rₚ(1)=132 ohms, the diode will be biased on when the total voltage is 1.6 volts. When using LED's for diodes 168 and 172, they may be selected to produce differently colored light to permit rapid visual determination as to whether one or both of the LED's are operating at a given time.

As has been mentioned and as is discussed further below, other types of detector devices may be used. For example, if a germanium diode is used in detector device 138(4), the appropriate value for the resistor Rₚ(1) is about 39 ohms.

FIG. 8 is a partial fragmentary illustration of an exemplary detector 88(5), similar to detector 88(4), attached to a stack 182 of fuel cell devices 82(4) as part of a fuel cell assembly 80(4). In particular, four fuel cell devices 82(4)a, 82(4)b, 82(4)c and 82(4)d have respective electrically conductive exposed plates or surfaces 184, 186, 188 and 190, corresponding to plates 40 depicted in FIG. 1. The exposed surfaces are spaced apart, so the voltage potential between cells is determined by measuring the relative voltages on the corresponding surfaces. In this example, an opening 192 is formed in the four surfaces, with the opening being sized to receive detector 88(5).

This detector includes a dielectric or other suitable substrate 194 on which is mounted a detector device 138(5) in the form of a circuit. On the ends of the substrate 194 are electrically conductive layers 196 and 198 that contact surfaces 184 and 190, respectively, when substrate 194 is seated in opening 192. In this example, these layers are attached to the substrate by adhesive, or they are made of a conductive adhesive. It is within the scope of the disclosure that any suitable attachment mechanism may be utilized, including versions that do not involve opening 192. Other illustrative examples of suitable attachment mechanisms for the detector relative to the fuel cell devices include attachment by an adhesive, by press fit, by pins, or by a mechanical capture device. A resistor Rₛ(2) and an electromagnetic energy transmitter 200, including, for example, an LED, are connected in series between the conductive layers via a conductive strip 202. Detector 88(5) is designed as described with reference to detector 88(4) shown in FIG. 7. The detector is mounted so that the electromagnetic energy produced by the transmitter exists at a location physically separate from the detector or the fuel cell devices, and is available to be monitored without making physical contact with the detector or the fuel cell devices. An illustrative location from which the light from transmitter 200 is visible is a suitable location to monitor the detector. For example, this may be provided by positioning the detector in such illustrative positions as with the exposed surface of substrate 194 flush with, recessed below, or elevated above the exposed surfaces 184, 186, 188 and 190.

The forms of detectors used in a fuel cell assembly are not limited to the forms described. For instance, two additional examples of detector assemblies are illustrated in FIGS. 9 and 10. In particular, FIG. 9 illustrates a detector 88(6) including a resistor Rₛ(2) and a light source 210 that are connected in series between two terminals 212 and 214. Electromagnetic energy, or more specifically, electromagnetic radiation 94(4) in the form of ultraviolet, visible or infrared light is produced by light source 210 in proportion to the voltage on the terminals and the effective resistance in the resistor and light source.

FIG. 10 illustrates a detector 88(7) including a resistor Rₛ(3) and an inductor coil 220 connected in series between terminals 222 and 224. Coil 220 produces electromagnetic energy 94(5) in the form of a magnetic field that is directly proportional to the voltage existing on terminals 222 and 224. Either of the detectors shown in FIGS. 9 and 10 may also include an in-line diode to prevent current flow at low voltage levels.

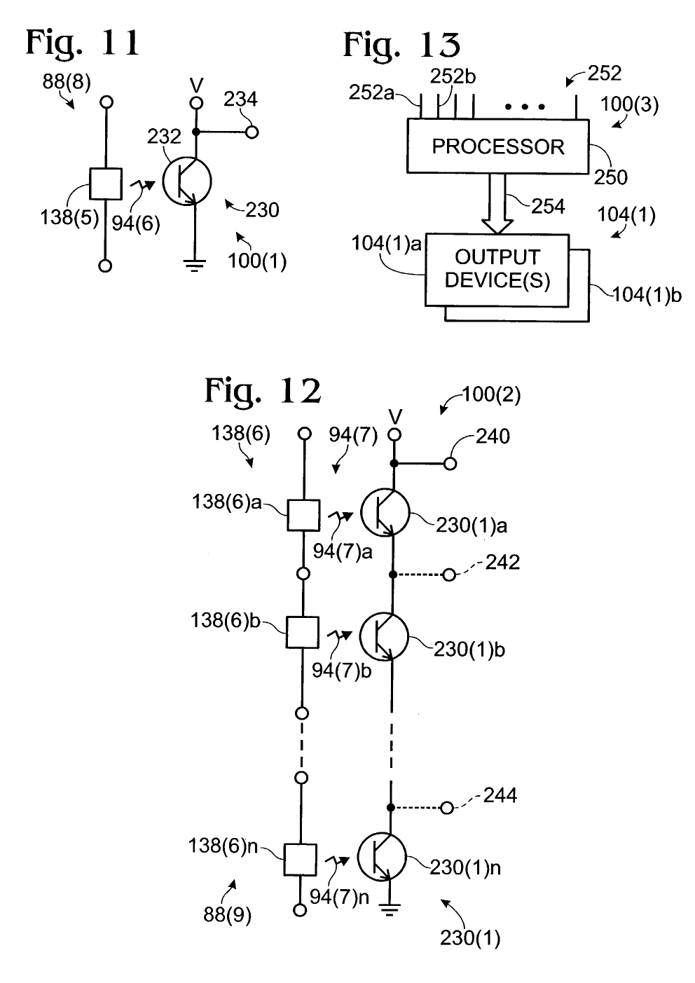

FIG. 11 discloses an exemplary detector 88(8) and a monitor 100(1). Detector 88(8) includes a detector device 138(5) that produces electromagnetic energy 94(6), as has been described. When electromagnetic energy in the form of visible or invisible light is emitted, in some examples, monitor 100(1) may include a monitor device 230 in the form of a phototransistor 232 or other photo-sensitive device. The phototransistor is biased to produce an output signal on a terminal 234 in response to the received electromagnetic radiation. In this example, terminal 234 is connected to an output device, not shown, as discussed with reference to FIG. 4.

FIG. 12 illustrates another configuration of a detector 88(9) with a monitor 100(2). Detector 88(9) includes a plurality of detector devices 138(6) connected in series, such as devices 138(6)a, 138(6)b and 138(6)n. Each device 138(6) detects the condition of one or a plurality of fuel cell devices, as has been described, and produces electromagnetic energy in response to the detected condition. The respective electromagnetic energy 94(7), such as electromagnetic radiation 94(7)a, 94(7)b and 94(7)n, is received by monitor devices 230(1), such as devices 230(1)a, 230(1)b and 230(1)n. As discussed above, examples of the monitor devices include phototransistors, as shown, or other suitable devices. The monitor devices are connected in series, as shown in solid lines, to produce a single output on a terminal 240. This configuration has two operating states. A low output signal is produced only when all monitor devices are turned on, or conducting. The failure of any one of them to conduct due to lack of a received electromagnetic signal, results in a high output signal. This, then, is a variation of the go/no go arrangement in which it is desired to repair or replace the fuel cell assembly when a single fuel cell device is not functioning as desired. It is within the scope of the disclosure that these binary states may (but are not required to) provide input for a digital control device.

Optionally, each monitor device 230(1) is individually biased to produce an output signal, as represented by the output terminals 242 and 244 shown in dashed lines, and as depicted in FIG. 11 for phototransistor 232, thereby allowing the individual fuel cell device or devices to be monitored. Depending on the detector and monitor devices used, the output signals include analog signals, digital signals, or both.

A further example of a portion of a monitor 100(3) including an information processor 250 coupled to one or a plurality of output devices 104(1), such as output devices 104(1)a and 104(1)b, is shown in FIG. 13. Processor 250 includes a plurality of input terminals 252, such as terminals 252a and 252b, that receive signals output by monitor devices, such as those shown in FIG. 12. The processor is adapted to multiplex the incoming signals and output them on a data bus represented by data arrow 254. In some examples, processor 250 is adapted to perform logic functions or includes a logic circuit adapted to perform logic functions to the data to produce the desired output signal.

It will be appreciated then that, in these examples, the operating state of one or a group of fuel cell devices is detected without direct physical contact with the fuel cell devices. That is, once a fuel-cell-device detector according to the disclosure is attached to a fuel cell device, monitoring of the fuel cell device may be obtained without further contact with the fuel cell device. If light-emitting devices are used for the detectors, visual inspection of the devices provides the information needed. If monitor devices are installed to receive produced electromagnetic energy, further automatic processing and control of the fuel cell assembly may be provided without further physical or electrical connection to the fuel cell assembly. In some examples, individual fuel cells or groups of fuel cells are monitored, and an indication of one fuel cell or one group of fuel cells not functioning as desired is provided.

### INDUSTRIAL APPLICABILITY

Fuel cell assemblies and apparatus described in the present disclosure are applicable to the fuel processing, fuel cell and other industries in which fuel cells are utilized to produce an electric current.

It is believed that the disclosure set forth above encompasses multiple distinct disclosures with independent utility. While each of these disclosures has been disclosed in its preferred form, the specific examples thereof as disclosed and illustrated herein are not to be considered in a limiting sense as numerous variations are possible. The subject matter of the disclosures includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that correspond to disclosed examples and are novel and non-obvious. Other combinations and subcombinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present disclosure.

1. A fuel cell assembly comprising:
a fuel cell device having a pair of electrical contacts, and adapted to generate a voltage between the pair of electrical contacts; and
a detector coupled to the pair of electrical contacts and adapted to produce electromagnetic radiation indicative of the voltage between the pair of electrical contacts.

2. The assembly of claim 1, wherein the detector is adapted to produce different levels of electromagnetic radiation for different levels of voltage between the electrical contacts.

3. The assembly of claim 2, wherein the detector is adapted to produce a first level of electromagnetic radiation when the voltage between the electrical contacts is at least a first voltage level, and a second level of electromagnetic radiation different than the first level of electromagnetic radiation when the voltage is below the first voltage level.

4. The assembly of claim 3, wherein the detector is further adapted to produce a third level of electromagnetic radiation when the voltage is below a second voltage level different than the first voltage level.

5. The assembly of claim 2, wherein the detector includes an electrical circuit powered by the fuel cell device.

6. The assembly of claim 5, wherein the detector further includes a semiconductor device that is biased to operate when the voltage difference is at least a first value.

7. The assembly of claim 6, wherein the semiconductor device is adapted to emit the electromagnetic radiation.

8. The assembly of claim 1, further comprising a monitor physically separate from the detector and adapted to detect the produced electromagnetic radiation and produce an output signal representative of the voltage difference.

9. The assembly of claim 8, wherein the monitor is also physically separate from the fuel cell device.

10. The assembly of claim 1, further comprising a plurality of the fuel cell devices connected in series, wherein the detector includes a plurality of the detector devices, with each fuel cell device being associated with at least one detector device.

11. The assembly of claim 10, wherein each detector device is coupled to a pair of contacts spanning a plurality of adjacent fuel cell devices, the assembly further comprising a monitor physically separate from the detector and adapted to detect the produced electromagnetic radiation from each detector device and produce an output signal representative of the detected radiation.

12. The assembly of claim 10, wherein each detector device is adapted to produce a first level of electromagnetic radiation when the voltage between the electrical contacts is at least a first voltage level, and a second level of electromagnetic radiation when the voltage is below the first voltage level, wherein the assembly further comprises a monitor adapted to detect the produced electromagnetic radiation from each detector device and produce a first output signal when all detector devices are producing the first level of electromagnetic radiation, and a second output signal when any detector is producing the second level of electromagnetic radiation.

13. The assembly of claim 10, wherein each detector device is coupled to a pair of contacts spanning a plurality of adjacent fuel cell devices, and a plurality of the fuel cell devices are each included in the plurality of adjacent fuel cell devices associated with each of a plurality of detector devices.

14. The assembly of claim 13, wherein a plurality of fuel cell devices are each associated with a unique set of detector devices.

15. The assembly of claim 13, further comprising a monitor physically separate from the detector and adapted to detect the produced electromagnetic radiation and to produce an output signal representative of the detected radiation.

16. The assembly of claim 15, wherein the monitor detects the electromagnetic radiation produced by each detector device and further includes logic circuitry for determining whether at least one fuel cell device is producing a reduced voltage.

17. The assembly of claim 1, wherein the fuel cell device has an exposed surface with an opening, and the detector is mounted on the fuel cell device with at least a portion of the detector positioned in the opening.

18. The assembly of claim 17, wherein the detector includes a photodiode and a current-limiting element connected in series between a plurality of fuel cell devices.

19. The assembly of claim 1, wherein the electromagnetic radiation includes at least one of visible light, infrared light, and radio waves.

20. The assembly of claim 1, wherein the fuel cell device includes at least one of a fuel cell, a fuel cell stack, a fuel cell system, and an energy-producing and consuming assembly.

21. A fuel cell assembly comprising:
a fuel cell device having a pair of electrical contacts, and adapted to generate a voltage between the pair of electrical contacts;
a detector coupled to the pair of electrical contacts and adapted to produce electromagnetic energy representative of the voltage difference; and
a monitor physically separate from the detector and adapted to detect the produced electromagnetic energy and produce an output signal representative of the voltage difference.

22. The assembly of claim 21, wherein the monitor is also physically separate from the fuel cell device.

23. The assembly of claim 22, wherein the monitor is not in contact with the fuel cell device.

24. The assembly of claim 21, wherein the detector is adapted to produce different levels of electromagnetic energy for different levels of voltage between the electrical contacts.

25. The assembly of claim 24, wherein the detector is adapted to produce a first level of electromagnetic energy when the voltage between the electrical contacts is at least a first voltage level, and a second level of electromagnetic energy different than the first level of electromagnetic energy when the voltage is below the first voltage level.

26. The assembly of claim 24, wherein the detector includes an electrical circuit powered by the fuel cell device.

27. The assembly of claim 26, wherein the detector further includes a semiconductor device that is biased to operate when the voltage difference is at least a first value.

28. The assembly of claim 27, wherein the semiconductor device is adapted to emit the electromagnetic energy when it operates.

29. The assembly of claim 28, wherein the electromagnetic radiation includes at least one of visible light, infrared light, and radio waves.

30. The assembly of claim 21, further comprising a plurality of the fuel cell devices connected in series and wherein the detector includes a plurality of detector devices, with each fuel cell device being associated with at least one detector device.

31. The assembly of claim 30, wherein each detector device is coupled to a pair of electrical contacts spanning a plurality of adjacent fuel cell devices, and a plurality of the fuel cell devices are each included in the plurality of adjacent fuel cell devices associated with each of a plurality of detector devices.

32. The assembly of claim 31, wherein each fuel cell device is associated with a unique plurality of detector devices.

33. The assembly of claim 31, wherein the monitor includes a monitor device associated with each detector device, and each monitor device is adapted to detect the electromagnetic energy produced by the associated detector device, and the monitor further includes logic circuitry for determining whether at least one fuel cell device is producing a reduced voltage.

34. The assembly of claim 33, wherein the electromagnetic energy is light, each detector device includes a light-emitting semiconductor device that produces the electromagnetic energy as light, and each monitor device includes a photo-sensitive semiconductor device responsive to light emitted by the associated light-emitting semiconductor device.

35. The assembly of claim 34, wherein each semiconductor device is biased to conduct electricity when the voltage is at least a minimum voltage.

36. The assembly of claim 21, wherein the fuel cell device includes at least one of a fuel cell, a fuel cell stack, a fuel cell system, and an energy-producing and consuming assembly.

37. A fuel cell assembly comprising:
a fuel cell device having a pair of electrical contacts, and adapted to generate a voltage between the pair of electrical contacts;
a detector coupled to the pair of electrical contacts and adapted to produce a first level of electromagnetic energy when the voltage between the electrical contacts is at least a first voltage level, and a second level of electromagnetic energy different than the first level of electromagnetic energy when the voltage is below the first voltage level; and
a monitor responsive to the produced electromagnetic energy and adapted to produce an output digital signal representative of the level of the produced electromagnetic energy.

38. The assembly of claim 37, further comprising a plurality of the fuel cell devices connected in series and wherein the detector includes a plurality of detector devices, with each fuel cell device being associated with at least one detector device.

39. The assembly of claim 38 wherein each detector device is coupled to a pair of electrodes spanning a plurality of adjacent fuel cell devices, and a plurality of the fuel cell devices are each included in the plurality of adjacent fuel cell devices associated with a plurality of detector devices.

40. The assembly of claim 39, wherein the monitor includes a monitor device associated with each detector device, each monitor device is adapted to detect the electromagnetic energy produced by the associated detector device, and the monitor further includes logic circuitry for determining whether at least one fuel cell device is producing a reduced voltage.

41. The assembly of claim 40, wherein the electromagnetic energy is light, each detector device includes a light-emitting semiconductor device that produces the electromagnetic energy as light, and each monitor device includes a photo-sensitive semiconductor device responsive to light emitted by the associated light-emitting semiconductor device.

42. A method of remotely monitoring the operation of a fuel cell device that produces a voltage between a pair of electrical contacts comprising:
detecting the voltage between the pair of electrical contacts;
producing electromagnetic energy indicative of the detected voltage; and
monitoring the produced electromagnetic energy.

43. The method of claim 42, wherein producing includes producing different levels of electromagnetic energy for different levels of voltage between the electrical contacts.

44. The method of claim 43, wherein producing further includes producing a first level of electromagnetic energy when the voltage between the electrical contacts is at least a first voltage level, and a second level of electromagnetic energy different than the first level of electromagnetic energy when the voltage is below the first voltage level.

45. The method of claim 43, wherein detecting includes operating an electromagnetic-energy producing electrical circuit with energy produced by the fuel cell device.

46. The method of claim 45, wherein operating includes operating a semiconductor device that is biased to operate when the voltage difference is at least a first value.

47. The method of claim 46, wherein the semiconductor device emits the electromagnetic energy when it operates.

48. The method of claim 42, wherein monitoring comprises detecting the produced electromagnetic energy spaced from the fuel cell device and in a manner producing an output signal representative of the voltage.

49. The method of claim 42, wherein detecting includes detecting a plurality of voltages, wherein each voltage is between a pair of electrical contacts spanning a plurality of the fuel cell devices connected in series and at least two of the voltages span overlapping series of fuel cell devices.

50. The method of claim 49, wherein detecting includes detecting a plurality of voltages spanning different sets of fuel cell devices, with a plurality of fuel cell devices each included in a plurality of the sets of fuel cell devices.

51. The method of claim 50, wherein monitoring comprises detecting the produced electromagnetic energy in a manner electrically isolated from the fuel cell devices and producing an output signal representative of the detected voltages.

52. The method of claim 51, wherein detecting electromagnetic energy includes detecting energy at a location physically separate from the fuel cell devices.

53. The method of claim 51, wherein detecting the electromagnetic energy further includes determining whether at least one fuel cell device is producing a reduced voltage.

54. The method of claim 42, wherein monitoring the produced electromagnetic energy includes monitoring the produced electromagnetic energy at a location physically separate from the fuel cell devices.

55. The method of claim 42, wherein monitoring the produced electromagnetic energy includes monitoring the produced electromagnetic energy with a monitor not in contact with the fuel cell device.

56. A fuel cell assembly comprising:
means for producing a voltage between a pair of electrical contacts by electrochemical reaction of a fuel and an oxidant;
means for detecting the voltage between the pair of electrical contacts; and
means for producing electromagnetic radiation indicative of the detected voltage.

57. The assembly of claim 56, wherein the radiation producing means produces different levels of electromagnetic radiation for different levels of voltage between the electrical contacts.

58. The assembly of claim 57, wherein the radiation producing means is further for producing a first level of electromagnetic radiation when the voltage between the electrical contacts is at least a first voltage level, and a second level of electromagnetic radiation different than the first level of electromagnetic radiation when the voltage is below the first voltage level.

59. The assembly of claim 57, wherein the detecting means is further for detecting the voltage using energy produced by the voltage-producing means.

60. The assembly of claim 56, further comprising means for monitoring the produced electromagnetic radiation in a manner electrically isolated from the voltage-producing means, and producing an output signal representative of the detected voltage.

61. The assembly of claim 60, wherein the monitoring means is further for monitoring the radiation at a location physically spaced from the voltage-producing means.

62. The assembly of claim 60, wherein the monitoring means is not in contact with the voltage-producing means.

63. The assembly of claim 56, wherein the detecting means is further for detecting a plurality of voltages, wherein each voltage is between a pair of electrical contacts spanning a plurality of the voltage-producing means connected in series and at least two of the voltages span overlapping series of voltage-producing means.

64. The assembly of claim 63, wherein the detecting means is further for detecting a plurality of voltages spanning different sets of voltage-producing means, with each of a plurality of voltage-producing means included in a plurality of the sets of voltage-producing means.

65. The assembly of claim 64, further comprising means for monitoring the produced electromagnetic radiation in a manner electrically isolated from the voltage-producing means and producing an output signal representative of the detected voltages.

66. The assembly of claim 65, wherein the means for monitoring the produced electromagnetic radiation is further for monitoring electromagnetic radiation at a location physically spaced from the voltage-producing means.

67. The assembly of claim 65, wherein the means for monitoring the produced electromagnetic radiation is further for determining if at least one voltage-producing means is producing a reduced voltage.
